(19) United States
(12) Patent Application Publication
(10) Pub. No.: US 2025/0078501 A1
(43) Pub. Date: Mar. 6, 2025

(54) Methods And Systems For Use In Processing Images Related To Boundaries

(71) Applicant: MONSANTO TECHNOLOGY LLC, Saint Louis, MO (US)

(72) Inventors: Hamidullah BINOL, Clemmons, NC (US); Balathasan GIRITHARAN, Chesterfield, MO (US); Patricio LA ROSA, Saint Louis, MO (US); Anderson Reis SOARES, Paraíba (BR)

(21) Appl. No.: 18/818,278

(22) Filed: Aug. 28, 2024

Related U.S. Application Data
(60) Provisional application No. 63/536,057, filed on Aug. 31, 2023.

(51) Int. Cl. G06V 20/10; G06V 10/26; G06V 10/28; G06V 10/762

(52) U.S. Cl. CPC G06V 20/188; G06V 10/26; G06V 10/28; G06V 10/762

(57) ABSTRACT

Systems and methods are provided for use in processing images related to boundaries. One example computer-implemented method includes accessing a data set of images, where the images define a time series of images over a time period and where each of the images includes a target agricultural field, and generating a data structure for the target agricultural field including at least a portion of the images. The method also includes segmenting the images in the data structure into a plurality of segments and aggregating data for the images included in each of the plurality of segments into super pixels. The method then further includes merging the super pixels into spatially contiguous regions and defining a field boundary of the target agricultural field, based on the spatially contiguous regions.

### CROSS-REFERENCE TO RELATED APPLICATION

This application claims the benefit of, and priority to, U.S. Provisional Application No. 63/536,057, filed Aug. 31, 2023. The entire disclosure of the above application is incorporated herein by reference.

### FIELD

The present disclosure generally relates to methods and systems for use in processing images related to boundaries, and, in particular, to methods and systems for use in enhancing spatial-temporal processing to accurately detect boundaries of agricultural fields.

### BACKGROUND

This section provides background information related to the present disclosure which is not necessarily prior art.

Images of agricultural fields are known to be captured in various manners, including, for example, by satellites, unmanned and manned aerial vehicles, etc. In addition, the images are known to have specific characteristics based on the manner in which the images are captured. The images of the agricultural fields, once captured, are further known to be processed, and then used to determine features of the agricultural fields, such as, for example, growth stages of crops planted in the agricultural fields.

### SUMMARY

This section provides a general summary of the disclosure, and is not a comprehensive disclosure of its full scope or all of its features.

Example embodiments of the present disclosure generally relate to computer-implemented methods for use in processing images related to boundaries. In one example embodiment, such a method generally includes accessing, by a computing device, a data set of images, the images defining a time series of images over a time period, each of the images including a target agricultural field; generating, by the computing device, a data structure for the target agricultural field including at least a portion of the images; segmenting, by the computing device, the images in the data structure into a plurality of segments; aggregating, by the computing device, data for the images included in each of the plurality of segments into super pixels; merging, by the computing device, the super pixels into spatially contiguous regions; and defining, by the computing device, a field boundary of the target agricultural field, based on the spatially contiguous regions. . . .

Example embodiments of the present disclosure also generally relate to systems for use in processing images related to boundaries. In one example embodiment, such a system generally includes a computing device configured to: access a data set of images, the images defining a time series of images over a time period, each of the images including a target agricultural field; generate a data structure for the target agricultural field including at least a portion of the images; segment the images in the data structure into a plurality of segments; aggregate data for the images included in each of the plurality of segments into super pixels; merge the super pixels into spatially contiguous regions; and define a field boundary of the target agricultural field, based on the spatially contiguous regions.

Example embodiments of the present disclosure also generally relate to computer-readable storage media including executable instructions for processing images related to boundaries. In one example embodiment, a computer-readable storage medium includes executable instructions, which when executed by at least one processor, cause the at least one processor to perform as described herein.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments, are not all possible implementations, and are not intended to limit the scope of the present disclosure.

FIG. 1 illustrates an example system of the present disclosure configured for processing images related to boundaries (e.g., related to field boundaries, etc.);

FIGS. 2A-2G include example images, which are illustrative of certain operations of the system of FIG. 1;

FIG. 3 is a block diagram of an example computing device that may be used in the system of FIG. 1; and

FIG. 4 illustrates a flow diagram of an example method, suitable for use with the system of FIG. 1, for processing images related to boundaries.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Images may be used to identify, and obtain insights into, different crop characteristics within agricultural fields in which the crops are planted/growing. However, a lack of accurate or proper boundaries associated with the agricultural fields limits the accuracy of the underlying analysis. That is, when a field boundary is inaccurate, the underlying data which is supposed to be representative of that field is either overly inclusive, or under inclusive as to the data analyzed. In this manner, yield prediction or other crop performance metric, for example, may be incorrect. And decisions based on the incorrect yield prediction or other metric may be likewise incorrect. While data analytics related to the images of the fields may be extremely helpful, accuracy of the data in the aggregate, i.e., all correct data, is a condition precedent to improved performance. As such, a technical problem exists in accurately determining field boundaries based on available images across differently sized fields, different crops and different regions.

Uniquely, the systems and methods herein enable identifying of agricultural field boundaries based on processing images of the agricultural fields. In particular, images are processed through spatiotemporal segmentation and spatiotemporal filtering in combination with regionalization techniques to define specific and accurate field boundaries for target ones of the agricultural fields (e.g., as represented in the images, etc.). That is, the present disclosure provides for a technical solution that enhances performance of a computing device in processing volumes of image data to accurately define field boundaries through the operations described herein. The field boundaries are therefore defined, for example, in real time or near real time, to enable accurate delineation of underlying data specific to the agricultural fields and additional services based thereon to provide in-field technical solutions.

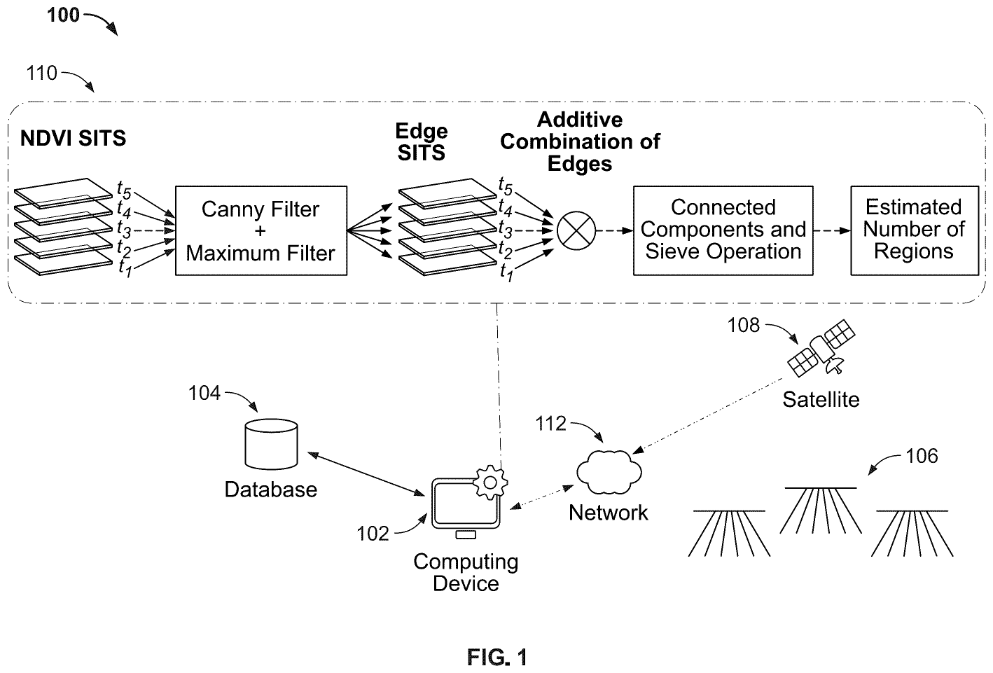

FIG. 1 illustrates an example system 100 in which one or more aspects of the present disclosure may be implemented. Although the system 100 is presented in one arrangement, other embodiments may include the parts of the system 100 (or additional parts) arranged otherwise depending on, for example, the types of images available, the manner in which the images are obtained, the types of crops included in the images, the number of fields present/available, etc.

As shown, the system 100 generally includes a computing device 102, and a database 104 coupled to (and is in communication with) the computing device 102, as indicated by the arrowed line. The computing device 102 and database 104 are illustrated as separate in the embodiment of FIG. 1, but it should be appreciated that the database 104 may be included, in whole or in part, in the computing device 102 in other system embodiments. The computing device 102 is also coupled to (and is in communication with) network 112. The network 112 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated parts of the system 100, or any combination thereof.

In this example embodiment, in general, the computing device 102 is configured to identify field boundaries of agricultural fields included in time-series images.

In connection therewith, the system 100 includes multiple agricultural fields 106. The fields 106, in general, are provided for planting, growing and harvesting crops, etc., for example, in connection with farming operations. While only three fields 106 are shown in FIG. 1, it should be appreciated that another number of fields may be included in other embodiments, including, for example, dozens, hundreds or thousands of fields, covering several acres (e.g., at least 1 or more acre, 10 or more acres, 50 or more acres, 100 or more acres, 200 or more acres, etc.). It should also be understood that the agricultural fields 106 may be understood to include (or to more generally refer to) growing spaces for crops, and which are exposed for satellite imaging (or other imaging) regardless of size, etc.

Further, the agricultural fields 106 may be populated with one or more crops as desired by a grower or farmer associated with the given one (or more) of the agricultural fields 106. The different crops (or plants) in the fields 106 a-c may include, for example (and without limitation), corn (or maize), wheat, beans (e.g., soybeans, etc.), peppers, tomatoes, tobacco, eggplant, corn or maize, rice, rye, sorghum, sunflower, potatoes, cotton, sweet potato, coffee, coconut, pineapple, citrus trees, prunes, cocoa, banana, avocado, fig, guava, mango, olive, papaya, cashew, almond, sugar beets, sugarcane, oats, barley, vegetables, or other suitable crops or products or combinations thereof, etc. In addition, the agricultural fields 106 may each include the same type of plants/crops, or a number of different varieties of the same type of plants (or crops), or different crops all together planted therein.

It should also be appreciated that the agricultural fields 106 (and other fields) may be located in proximity to one another, or not, whereby multiple of the agricultural fields are included in one or more images.

As shown, the system 100 also includes a satellite 108. With respect to FIG. 1, in particular, the satellite 108 is disposed in orbit about the Earth (which includes the agricultural fields 106) and is configured to capture images of one or more of the agricultural fields 106. As indicated above, the satellite 108 may be part of a collection of satellites (including multiple companion satellites) that orbit the Earth and capture images of different agricultural fields, including the agricultural fields 106. In this example embodiment, satellites (including the satellite 108) form a network of satellites, which, individually and together, is/are configured to capture one or more images, at an interval of once per N days, for example, where N may include one day (i.e., daily), two days, five days, seven days (i.e., weekly), ten days, 15 days, 20 days, 25 days, 30 days, numbers of days therebetween, more than 30 days, etc., thereby defining a temporal resolution of satellite images of (or captured for) the agricultural fields 106. More generally, the images may be captured at one or more regular or irregular intervals. Also, the satellite images may include different resolutions, depending on the particular type of satellite 108 employed in capturing the images. In one example, the images may include a resolution of about 10 meters by 10 meter per pixel, while in another example, the images may include a solution of about three meters by three meters, etc. In other still example, the resolution may be higher, or lower, again, depending on the satellite 108 (or other apparatus) employed in capturing the images.

After the image(s) are captured, the satellite 108 is configured to transmit the images to the database 104, either directly, or via one or more computing devices, etc. (e.g., via network 112 and computing device 102 as illustrated in FIG. 1, etc.). The database 104 is configured to, in turn, receive the one or more images from the satellite 108 and to store the satellite images in memory thereof, in a suitable manner. In this way, the database 104 includes multiple images over a time period (e.g., as a time series of images, etc.), which may correspond to the year, multiple years, a growing season, etc., depending on the start date and duration of the time period.

It should be understood that the database 104 may be configured to perform one or more processing operations in connection with storing the satellite images. For example, the database 104 may be configured to perform cloud detection, atmospheric correction, etc., whereby certain images are excluded from the database 104, at least for certain locations and/or time periods. Based on the pre-processing by the database 104, the time series of images in the database 104 for a particular location, or for a series of locations, may include daily images in one week and two images in a subsequent week, etc., based on the weather in the region at the time the images are captured (e.g., cloudy versus clear, etc.). The time series of images, consequently, may define various regular or irregular intervals among the images therein, etc.

In this example embodiment, in connection with identifying field boundaries, the computing device 102 is configured to access a data set including images of one or more agricultural fields 106, from the database 104 for a time period. The images are accessed based on a location, such as, for example, a centroid of a target one of the agricultural fields 106 (i.e., a target agricultural field), which is extended outward (by a radius or buffer) from the centroid location by kilometers, miles, etc., in one or more or all directions. The time period may include one or more months, based on, for example, a planting date for the target agricultural field, or otherwise. In at least one example, the time period is based on a plating date of the target agricultural field and a date on which a prediction is needed (e.g., in response to a yield prediction request, which defines the end date of the time period, etc.).

Based on the accessed data set, the computing device 102 is configured to then generate a data structure (e.g., a data cube or data matrix, etc.). In particular, the computing device 102, in generating the data structure, is configured to stack the images in time order from the initial date to the last date, whereby the pixels for the same physical location (or approximate location) are stacked over one another. In this manner, the data structure may include dozens or hundreds of images of the same physical locations, including the target agricultural field, over the time period (at one or more regular or irregular intervals).

Further, in connection with generating the data structure, the computing device 102 is also configured to generate one or more indices based on the images and to append the indices to the images in the data structure.

For example, the set of images includes specific wavelength band data or band data, per pixel per image, which relate to the color RED (e.g., having wavelengths ranging between about 635 nm and about 700 nm, etc.), the color BLUE (e.g., having wavelengths ranging between about 490 nm and about 550 nm, etc.), the color GREEN (e.g., having wavelengths ranging between about 520 nm and about 560 nm, etc.), and near infrared (NIR) (e.g., having wavelengths ranging between about 800 nm and about 2500 nm, etc.), etc. It should be appreciated that more or less band data may be identified from (or included in) the images in other embodiments. Then, based on such band data, the computing device 102 is configured to compute one or more of the example indices, which are defined in the equations below. For example, the indices may include vegetative indices, such as the Normalized Difference Vegetation Index (NDVI), the Bare Soil Index (BSI), the Enhanced Vegetation Index 2 (EVI2), and the Modified Soil Adjusted Vegetation Index (MSAVI), etc.

$$NDVI = \frac{( NIR - Red )}{( Nir + Red )} \\ BSI = \frac{( ( Red + Blue ) - Green )}{( ( Red + Blue ) + Green )} \\ EVI 2 = 2.5 * \frac{( Nir - Red )}{( Nir + 6 * Red - 7.5 * Blue + 1 )} \\ MSAVI = \frac{( 2 * Nir + 1 - \sqrt{{( 2 * Nir + 1 )}^{2} - 8 * ( Nir - Red )} )}{2}$$

It should be appreciated that the above-described indices are example only. Other indices based on the band data, or combinations thereof, whether indicative of vegetation or not, may be generated by the computing device 102 in other system embodiments (and then appended to the data structure, etc.).

Once the above indices are computed, the computing device 102 is configured to append the indices to the data structure (e.g., as an additional layer or entry per pixel, per image, etc.), whereby each pixel in each image of the time series of images includes data indicative of RED, GREEN, BLUE, NIR, NDVI, BSI, EVI2, and MSAVI. In this manner, the data structure is a multi-variate data structure for the specific target agricultural field.

Next, based on the data structure for the images for the target agricultural field, the computing device 102 is configured to perform spatiotemporal segmentation.

In connection therewith, the computing device 102 is configured, by using a simple nonlinear iterative temporal clustering (SNITC) algorithm, to divide the time series of images into spatiotemporal objects, which are referred to as spatiotemporal super pixels. The SNITC algorithm is a regularized version of the clustering method K-means. See, e.g., Soares, A., Korting, T., Fonseca, L., & Bendini, H. (2021), Simple Nonlinear Iterative Temporal Clustering, in IEEE Transactions on Geoscience and Remote Sensing (Vol. 59, Issue 9, pp. 7669-7679), Institute of Electrical and Electronics Engineers (IEEE). The SNITC algorithm configures the computing device 102 to iteratively group time series of pixels leveraging the Dynamic Time Warping (DTW) to find the best global alignment between two time series. The distance function of the SNITC algorithm is given by:

$$D = \sqrt{{D}_{T}^{2} + {m}^{2} \times {( \frac{{D}_{s}}{S} )}^{2}}$$

where D is a final distance, which is a sum of a DTW distance and an XY plane distance normalized by a grid interval S. A variable m is a compactness parameter introduced to D to control the compactness of the super pixel(s). The greater the value of variable m, the more the spatial distance is emphasized, and then the more compact the super pixel(s) is. D_{T} is the temporal distance defined by DTW.

In particular, the clustering algorithm relies on the time-series data, as included in the images or the computed indices, over time, to cluster the pixels into the segments having limited variation. It should be appreciated that the segments are limited in size (e.g., in acres, etc.) and homogeneity of the data (e.g., RED, GREEN, BLUE, NIR, NDVI, BSI, EVI2, and MSAVI, etc.) included therein. In this example, the segments may be limited to one acre, two acres, three acres, or more or less, etc., depending on, for example, the resolution of the images, size of the fields, etc. This indication, or definition, of the size (e.g., minimum area, etc.) that a segment may have, is an example parameter (e.g., a hyperparameter, etc.) for use in the system 100 (and method 400) herein. In connection with the data structure, the computing device 102 is configured to segment the images based on three or more images in this example, where the segmentation is generally improved with more images.

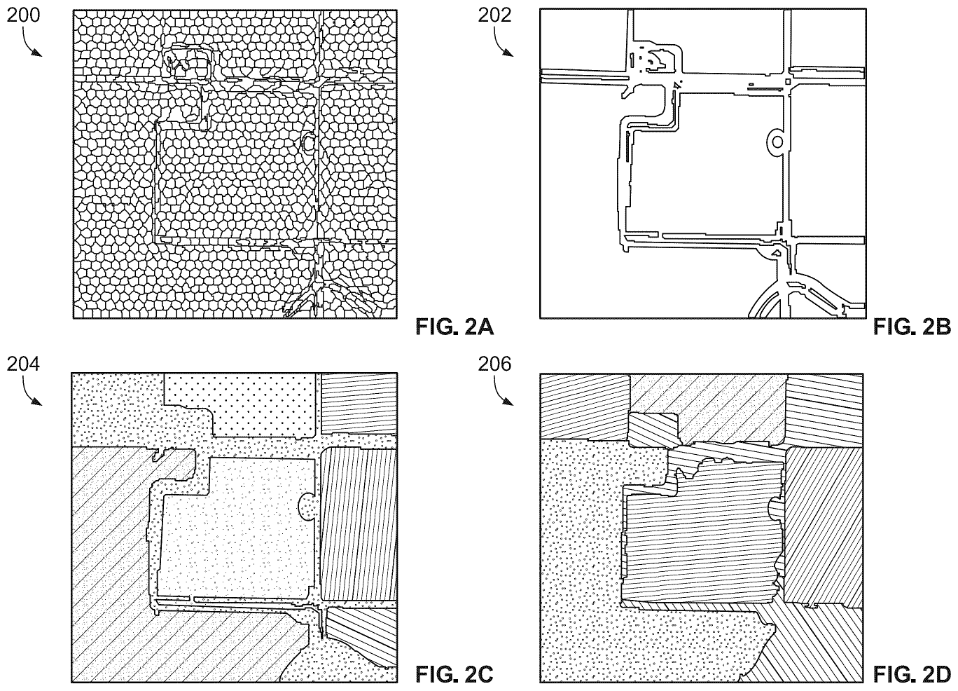

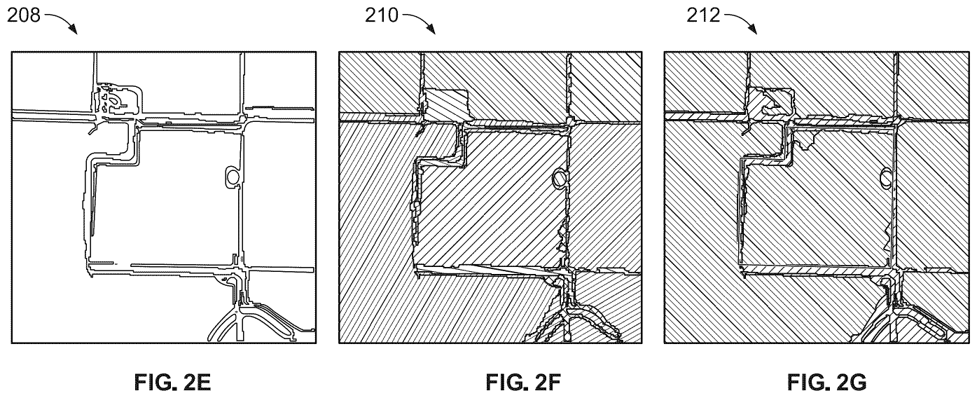

FIG. 2A illustrates (at 200) an example segmentation of an image into a plurality of segments, which are outlined therein.

After the plurality of segments are defined, the computing device 102 is configured to aggregate the pixel data, for each defined segment, per band and/or per index (or indices), into a super pixel for that segment. For example, the super pixel may include separate averages for NDVI, BSI, EVI2, and MSAVI, and also RED, GREEN, BLUE, NIR, etc. In this manner, the super pixels provide primitive representations of the images, which are effective in reducing volume of data in the data structure and also ensuring spatial contiguity between super pixels.

The super pixel values are then associated with each of the illustrated segments (e.g., with each of the segments shown in FIG. 2A, etc.), whereby the super pixel values are appended to the data structure (in the database 104) for the images for the target agricultural field (for the group of pixels in each of the segmentations).

Next, the computing device 102 is configured to cluster the super pixels (as represented in FIG. 2A) into regions, based on, in this example, spatial clustering, also known as regionalization. This technique aims to group a large set of spatial objects into a number of spatially contiguous regions. The number of regions may be determined, however, in this example embodiment, to use a number of connected components in an image, obtained after a spatiotemporal filtering operation. The number of regions is another example parameter (e.g., another hyperparameter, etc.) for use in the system 100 (and method 400) herein (e.g., for use in a regionalization algorithm (discussed hereinafter) to ultimately determine the fields; etc.). The number of regions is used in combination with an objective function (Fₛ) (as indicated below) to define an optimum number of regions in the time series of images, through an optimization process.

Based on the above, then, the computing device 102 is configured to merge the set of super pixels into a number of spatially contiguous regions. The main parameter thereof is an initial number of fields within the time series of images. In connection with the above, the computing device 102 is configured to use a number of connected components in the image, obtained after a spatiotemporal filtering, as presented in architecture 110 in FIG. 1. As shown, the NDVI images over time (t₁, t₂ . . . tₛ) are input to a combination of a Canny edge detection filter and a maximum filter. It should be understood that other data from the images (e.g., RED, BSI, EVI2, and MSAVI, etc.) may be used in other embodiments, along with other techniques for edge detection, etc.

In this example embodiment, the computing device 102 is configured to perform a contrast enhancement of the NDVI images to highlight transitions that are later highlighted by the Canny edge detection filter. The contrast enhancement is done by clipping the upper and lower bound/limit of each NDVI image (e.g., in one embodiment with the upper bound/limit set to 2 percent and the lower/bound limit set to 98 percent, or other range in other embodiments, etc.). The Canny edge detection filter has a σ parameter (e.g., as another hyperparameter, etc.) that defines the window size of the Gaussian smoothing initially applied by the filtering approach. After the edge detection for each date, the computing device 102 is configured to apply the maximum filtering. The maximum filtering is a convolution filter, which may be applied over the image with a 3×3 kernel to assign to the center pixel the highest value from the image in the location the kernel overlaps. In this example, the kernel size is limited to 3×3 to preserve the edges (e.g., to preserve the thin edges, etc.). In this manner, the filtering provides for the edges to be enlarged to avoid possible leaks due to disconnected edges. The filtering, as shown in FIG. 1, in the architecture 110, provides a times series of edges. The computing device 102 is configured, through the architecture 110, to combine the time series of edges, through an additive combination, to define one single edge layer. The computing device 102 is configured to then binarize based on the classification of the value of the data below:

$$\{ \begin{matrix}if value > 0 , value = 1 \\ else , value = 0\end{matrix}$$

FIG. 2B illustrates (at 202) an example binary output from the architecture 110, for the underlying image that was segmented in FIG. 2A.

In this example, the computing device 102 is configured, through the architecture 110, to perform a connected operation on the binary edge layer output (e.g., as shown in FIG. 2B, etc.), by assigning a given label to each set of pixels that are contiguous, and not separated by an edge. In this manner, edges define a change in the label, whereby contiguous regions are defined and separated by edges. It should be appreciated that a different sized set of pixels and/or shape of pixels may be used to define the regions in other embodiments. With respect to the example if FIG. 2B, the computing device 102 performs the connected operation to assign different labels as different colors/hatching in the connected component image, whereby the regions then illustrated in FIG. 2C (at 204) are defined by the connected operation (e.g., as represented by the different hatching in this example, etc.).

As shown in the architecture 110 in FIG. 1, the computing device 102 is configured to impose a sieve operation (e.g., on the output shown in FIG. 2C, etc.), which removes connected components less than a first predefined threshold size. This minimum size of a valid region/field is another example of a parameter (e.g., another hyperparameter, etc.) for use in the system 100 (and method 400) herein. For example, the computing device 102 may be configured to merge connected components with a larger (or largest) neighbor when the connected component is less than about 500 pixels, is less than about 1000 pixels, is less than about 2000 pixels, or more or less, etc. The first predefined threshold size may relate, for example, to a size of a field area to be detected. This value may change from region to region, for example, given the landscape characteristics, etc. As such, in various examples, this value may required tuning for different locations. The computing device 102 is further configured to estimate a range of fields in the image based on, for example, an estimate from the edge detection or otherwise.

In connection with the above, a regionalization approach configures the computing device 102 to iteratively merge super pixels. This process is performed based on the range of estimated fields, related with previous operation, and the optimization function (Fₛ). Based on the number of estimated fields, iteratively, a regionalization algorithm configures device 102 to merge super pixels until a certain (e.g., threshold, etc.) number is achieved. This merge can follow a top-down or bottom-up approach, to result in a set of spanning trees.

Once the merge operation is performed, the computing device 102 is configured to rely on a metric suitable to assess the quality of the partition. In one or more embodiments, the metric for field boundary delineation is a function, Fₛ, based on the F1-score metric. The function combines a spatiotemporal autocorrelation (STA) and an area weighted spatiotemporal variance (STWV) metric in a fitting score (Fₛ) to define the number of clusters. Accordingly, the metrics cooperate to define regions having limited or minimum internal variance within and also enhanced or maximum spatiotemporal heterogeneity between the different regions.

As such, the computing device 102 is configured, in connection with computing the fitting score, to normalize STA and STWV by its difference with the maximum value obtained for the different number of regions tested. The computing device 102 is configured to then combine the spatiotemporal inter-region heterogeneity and the spatiotemporal weighted variance using the Fₛ function. In doing so, the computing device 102 is configured to compute the metric for each merge that is performed based on the range of estimated fields in the image, for example, based on:

$${F}_{s} = ( 1 + {a}^{2} ) \frac{F ( STA ) \times F ( STWV )}{{a}^{2} \times F ( STA ) + F ( STWV )}$$

In the above, a is a weight which controls the relative weights of F(STWV) and F(STA) (which are normalization functions of STA and STWV). For example, α=1 indicates equal weighting for F(STWV) and F(STA), while α=0.5 indicates half weighting for F(STWV), and α=2 indicates double weighting for F(STWV). Fₛ values range from 0 to 1, with higher values indicating higher segmentation quality.

For example, the computing device 102 may be configured to first compute the spatiotemporal inter-region heterogeneity based on spatiotemporal autocorrelation (STA), which is an exploratory approach to recognizing data distribution and measure the degree of this relationship across space and time. This autocorrelation indicates the similarity of the dynamic behavior and the accumulative magnitude of time series in neighbor places.

Based on the spatiotemporal arrangement, the range of values of the spatiotemporal autocorrelation is from −1 to 1. To account for the spatiotemporal autocorrelation, the approach proposed by Gao, Y., Cheng, J., Meng, H., & Liu, Y. (Measuring spatio-temporal autocorrelation in time series data of collective human mobility, in Geo-spatial Information Science (2019, Vol. 22, Issue 3, pp. 166-173)) may be utilized, that extends the Global Moran's I to the spatiotemporal domain. That said, in order to apply this approach to a time series of data, as described herein, and obtain an indication of the degree of linear association between a univariate time series at a given region and the weighted average of its neighbors, defined based on contiguity or on a spatial distance, the computing device 102 is configured to compute a difference between the average time series at a region i and the series of global averaged time series. This deviation is computed as a dissimilarity between two time series by the first-order temporal correlation coefficient, defined as:

$$CORT ( {X}_{T} , {Y}_{T} ) = \frac{{\sum }_{t}^{T - 1} ( {X}_{t + 1} - {X}_{t} ) ( {Y}_{t + 1} - {Y}_{t} )}{\sqrt{{\sum }_{t}^{T - 1} {( {X}_{t + 1} - {X}_{t} )}^{2} \sqrt{{\sum }_{t}^{T - 1} {( {Y}_{t + 1} - {Y}_{t} )}^{2}}}}$$

where X_{T} and Y_{T} are two series with T length, and where Xₜ and Xₜ₊₁ are observations at the time t and t+1.

The result of this formula ranges from −1 to 1. The result of −1 represents that X_{T} and Y_{T} share a similar growth in rate but opposite in direction, while 1 indicates that the terms have a similar growth both in rate and direction. The result of 0 means their growth rates are stochastically linearly independent, so they have different temporal behaviors. Then, the temporal variance and accumulative volume are integrated to set up the deviation measure, defined as:

$$( {X}_{T} , {Y}_{T} ) = ϕ ( CORT ( {X}_{T} , {Y}_{T} ) ) * ( {V}_{X} - {V}_{Y} )$$

where D(X_{T}, Y_{T}) is the deviation of two time series X_{T} and Y_{T}, and V_{X} and V_{Y} are the accumulative volumes in period [1, T] of X_{T} and Y_{T}, respectively. And, ϕ is an exponential adaptive tuning function, which is defined as:

$$ϕ ( x ) = \frac{2}{1 + {e}^{2 x}}$$

As SITS data are represented as a set of spatio-temporal series {Xᵢ^{T}, i=1, 2, . . . , N}, where N is the number of locations, Xᵢ^{T} is a time series at region i, Xᵢ^{T}={Xᵢₜ^{T}, t=1, 2, . . . , T}, and all Xᵢ^{T} have the same length T. The mean of {Xᵢ^{T}} is a series of the mean value at each time, i.e. X̅^{T}={m̅ₜ, t=1, 2, . . . , T} where:

$${\overline{m}}_{t} = {\sum }_{i}^{N} {X}_{it}^{T} / N .$$

In connection with the above, then, the spatio-temporal autocorrelation index (STA) is defined as:

$$STA = \frac{N}{{\sum }_{i}^{N} {\sum }_{j}^{N} {W}_{ij}} \frac{{\sum }_{i}^{N} {\sum }_{ij}^{N} {W}_{ij} {Z}_{i}^{T} {Z}_{j}^{T}}{{\sum }_{i}^{N} {Z}_{i}^{{T}^{2}}}$$

where: W is the spatial weight matrix and Zᵢ^{T} is the deviation between the time series at location i and the mean series, defined as:

$${Z}_{i}^{T} = ϕ ( CORT ( {X}_{i}^{T} , {X}^{T} ) ) * ( {V}_{i} - \overline{V} )$$

where: Vᵢ is the accumulative volume of Xᵢ^{T}, and {V} is the accumulative volume of \ overline X^{T}.

The computing device 102 is configured to then compute the second metric, which is the fitting score, to assess degree of internal homogeneity within a region. The spatiotemporal weighted variance (STWV) measures the temporal dissimilarity of all-time series trends at pixel level for a given attribute (e.g., NDVI, BSI, EVI2, MSAVI, RED, GREEN, BLUE, NIR, or combination thereof, etc.) based on the Dynamic Time Warping (DTW) distance. The DTW distance defines a discrete matching between elements of one series to another series (e.g., in the images over time, etc.). The metric is computed as follows:

$$STWV = \frac{{\sum }_{i = 1}^{N} {C}_{{v}_{i}} \times {Area}_{i}}{{\sum }_{i = 1}^{N} {Area}_{i}} \\ where \\ {C}_{v} = \frac{DTW ( {C}_{{i}_{ndvi}} - {\overline{C}}_{ndvi}^{\cdot } )}{( N - 1 )}$$

In the above, DTW is the function of dissimilarity between two time series; N is the number of pixels in that region; Cᵢ_{_{nqvi}} is the NDVI time series i of cluster C; C̅_{ndvi} is the average NDVI time series of cluster C; and Area is the area of the super pixel in square meters.

Once the optimum number of regions is defined using the Fₛ metric, the regionalization is performed, using the optimum parameter found, in combination with the merge connected components and the sieve operation, described above, on the labelled image above (e.g., as depicted in FIG. 2C, etc.). The result of the regionalization is a set of polygons (e.g., as shown in FIG. 2D (at 206), etc.), which are defined as a list of vertices and paths, and with a property that uniquely identify each region. The result of the regionalization of the super pixels, along with labeling and the sieve operation, to the image in FIG. 2C is then depicted in FIG. 2D. Again, each of the estimated regions is illustrated in a different color/hatching (e.g., a different hatching in this example, etc.).

In this example embodiment, the computing device 102 is configured to perform one or more post-processing operations to further define the field boundaries.

In particular, for example, the computing device 102 is configured to define edges on the images, through edge detection. In connection therewith, the computing device 102 is configured to transform the vector data from the regions defined above, whereby the regions are defined as connected components in the same resolution as the input image time series, i.e., the labelled image. For this task, the computing device 102 is configured to create an image with the same planar dimensions of input image time series and each pixel is assigned a value that uniquely identifies the respective field defined by the regionalization process. The result of this process is a grid of cells where each cell has a value, that represents a region and an associated pair of spatial coordinates. This grid, then, may be referenced as a labelled image.

The computing device 102 is configured to then define edges, also based on spatiotemporal filtering. The spatiotemporal filtering is different than the edge detection in the architecture 110, because, in this example, enlarging the edges (e.g., based on the 3×3 kernel, etc.) is omitted. Rather, each pixel is assessed as an edge, or not. The defined edges for this example are illustrated in FIG. 2E (at 208). As compared to FIG. 2B, the edge detection is more precise in FIG. 2E.

The computing device 102 is configured to add edges to the labelled image, based on the expression below:

$${edge}_{imposed} = {labelled}_{image} + ( {edge}_{image} * 65535 )$$

In particular, the expression configures the computing device 102 to change the labels of the pixels where the edges are detected in the labeled image. FIG. 2F illustrates (at 210) the refined labelled image with the addition of the edges as defined above (e.g., where FIG. 2F is produced based on input of FIGS. 2D and 2E, etc.).

The computing device 102 is configured to define the regions of the image based on a four-connected neighborhood, which is the four pixels on top, bottom, left and right sides of a given pixel. When the four-neighbor touches an edge, a regional delineation is realized. In addition, thereafter, similar to the above, the computing device 102 is configured to impose a sieve operation, which removes connected components less than a second predefined threshold size (which, in this example, is generally smaller than the first predefined threshold size). For example, the computing device 102 may be configured to merge connected components with a larger (or largest) neighbor when the connected component is less than 25 pixels, 50 pixels, 100 pixels, or more or less, etc.

Thereafter, the computing device 102 is configured to transform the image to vector format. An example final output using the daily images from a start of a growing season to the end (i.e., the data set including images of one or more agricultural fields 106) is shown in FIG. 2G (at 212). The final output of field boundary delineation is a set of polygons that defines the fields and other objects within the image. The polygons may then be used to define the specific agricultural fields 106 to leverage any suitable digital agricultural product that requires accurate boundary information. This data can also be used to support precision harvest activities as the computing device 102 may be configured to export the polygons in multiple formats and stored in geographic database systems.

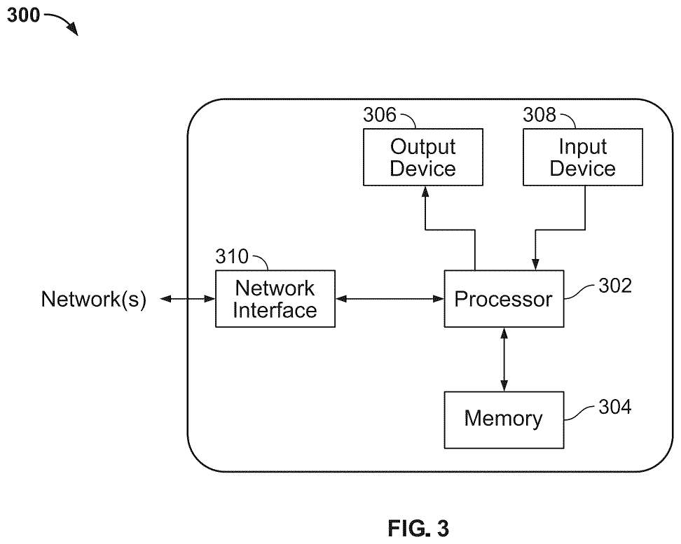

FIG. 3 illustrates an example computing device 300 that may be used in the system 100 of FIG. 1. The computing device 300 may include, for example, one or more servers, workstations, personal computers, laptops, tablets, smartphones, virtual devices, etc. In addition, the computing device 300 may include a single computing device, or it may include multiple computing devices located in close proximity or distributed over a geographic region, so long as the computing devices are specifically configured to operate as described herein. In the example embodiment of FIG. 1, the computing device 102, the database 104, and the satellite 108 may each include and/or be implemented in one or more computing devices consistent with (or at least partially consistent with) computing device 300. However, the system 100 should not be considered to be limited to the computing device 300, as described below, as different computing devices and/or arrangements of computing devices may be used. In addition, different components and/or arrangements of components may be used in other computing devices.

As shown in FIG. 3, the example computing device 300 includes a processor 302 and a memory 304 coupled to (and in communication with) the processor 302. The processor 302 may include one or more processing units (e.g., in a multi-core configuration, etc.). For example, the processor 302 may include, without limitation, a central processing unit (CPU), a microcontroller, a reduced instruction set computer (RISC) processor, a graphics processing unit (GPU), an application specific integrated circuit (ASIC), a programmable logic device (PLD), a gate array, and/or any other circuit or processor capable of the functions described herein.

The memory 304, as described herein, is one or more devices that permit data, instructions, etc., to be stored therein and retrieved therefrom. In connection therewith, the memory 304 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media for storing such data, instructions, etc. In particular herein, the memory 304 is configured to store data including and/or relating to, without limitation, images (e.g., satellite images, connected component images, labeled images, etc.) and/or other types of data (and/or data structures) suitable for use as described herein. Furthermore, in various embodiments, computer-executable instructions may be stored in the memory 304 for execution by the processor 302 to cause the processor 302 to perform one or more of the operations described herein (e.g., one or more of the operations of method 400, etc.) in connection with the various different parts of the system 100, such that the memory 304 is a physical, tangible, and non-transitory computer readable storage media. Such instructions often improve the efficiencies and/or performance of the processor 302 that is performing one or more of the various operations herein, whereby such performance may transform the computing device 300 into a special-purpose computing device. It should be appreciated that the memory 304 may include a variety of different memories, each implemented in connection with one or more of the functions or processes described herein.

In the example embodiment, the computing device 300 also includes an output device 306 that is coupled to (and is in communication with) the processor 302. The output device 306 may output information (e.g., field boundary images, etc.), visually or otherwise, to a user of the computing device 300, such as a researcher, grower, etc. It should be further appreciated that various interfaces (e.g., as defined by network-based applications, websites, etc.) may be displayed at computing device 300, and in particular at output device 306, to display certain information to the user. The output device 306 may include, without limitation, a liquid crystal display (LCD), a light-emitting diode (LED) display, an organic LED (OLED) display, an “electronic ink” display, speakers, etc. In some embodiments, output device 306 may include multiple devices. Additionally, or alternatively, the output device 306 may include printing capability, enabling the computing device 300 to print text, images, and the like on paper and/or other similar media.

In addition, the computing device 300 includes an input device 308 that receives inputs from the user (i.e., user inputs) such as, for example, selections of target fields, etc. The input device 308 may include a single input device or multiple input devices. The input device 308 is coupled to (and is in communication with) the processor 302 and may include, for example, one or more of a keyboard, a pointing device, a touch sensitive panel, or other suitable user input devices. In addition, the input device 308 may include, without limitation, sensors disposed and/or associated with the computing device 102. It should be appreciated that in at least one embodiment an input device 308 may be integrated and/or included with an output device 306 (e.g., a touchscreen display, etc.).

Further, the illustrated computing device 300 also includes a network interface 310 coupled to (and in communication with) the processor 302 and the memory 304. The network interface 310 may include, without limitation, a wired network adapter, a wireless network adapter, a mobile network adapter, or other device capable of communicating to one or more different networks (e.g., one or more of a local area network (LAN), a wide area network (WAN) (e.g., the Internet, etc.), a mobile network, a virtual network, and/or another suitable public and/or private network capable of supporting wired and/or wireless communication among two or more of the parts illustrated in FIG. 1, etc.) (e.g., network 112, etc.), including with other computing devices used as described herein.

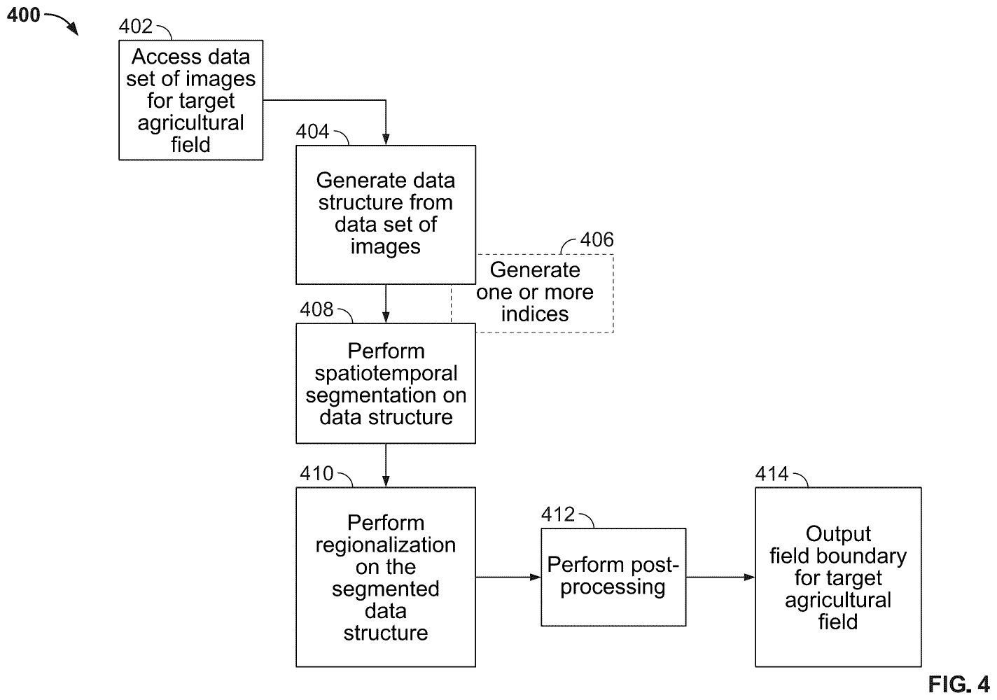

FIG. 4 illustrates an example method 400 for processing images of agricultural fields to identify field boundaries included therein. The method 400 is described herein in connection with the system 100, and may be implemented, in whole or in part, in the computing device 102 of the system 100. Further, for purposes of illustration, the example method 400 is also described with reference to the computing device 300 of FIG. 3. However, it should be appreciated that the method 400, or other methods described herein, are not limited to the system 100 or the computing device 300. And, conversely, the systems, data structures, and the computing devices described herein are not limited to the example method 400.

In connection with the above, the method 400 may be performed, in whole or in part, in real time or near real time. Real time may refer to within about ten milliseconds, about one hundred milliseconds, about one second, etc. And, near real time may refer to more than about one second but within about one minute, about five minutes, or up to about thirty minutes, etc.

With that said, at the outset, at 402, the computing device 102 accesses, from the database 104, a data set including images of one or more agricultural fields 106, from the database 104 for a time period.

The specific images may be accessed based on association with a target agricultural field. For example, the computing device 102 may determine a centroid location of the target agricultural field and access images associated with that location. The computing device 102 may access images specific to that location and then that also extend one or more kilometers in one or more directions therefrom (e.g., centroid location plus two or three or four, etc., kilometers in each direction (e.g., as a radius, etc.), etc.). The accessed images may further be aligned based on the centroid location, or other suitable location and/or data associated with the images or the target agricultural field.

The time period may include one or more months, based on, for example, a planting date for the target agricultural field, or otherwise. What's more, the time period may extend from planting until harvest or later in the growing stage or after, or some lesser interval therebetween. In one example, the time period extends between different growing seasons (e.g., from a certain growth stage until planting the next season, etc.). Also, the set of images may include each available image within the time period, such as, for example, daily images, etc., or a limited set of the images based on one or more filtering parameters (e.g., based on number of images, weather conditions associated with the target agricultural field when the images were captured (e.g., cloudy, etc.), etc.). For example, the set of images may include an image per week or two images per week or four images per week for different parts of the time period. The number of images and/or a frequency of the images may be dependent on the type of crops in the target agricultural field. For example, certain crops may grow more slowly and provide for less frequency of images, while other crops may define more frequent images during certain growth stages than other growth stages. In this manner, the images may be provided at one or more regular or irregular intervals during the time period.

In connection with accessing the set of images, in one example, the field boundary may be required for a specific digital data service related to the agricultural field during a growing season. In such an example, the computing device 102 may receive a request for the field boundary, which includes an identification of the target agricultural field and also a current date. The current date, in turn, defines the time period of the accessed data set of images, i.e., from the planting date (for example) to the date included in the request.

The computing device 102 then generates, at 404, a data structure (e.g., a data cube, etc.) based on the accessed set of images.

In particular, the computing device 102, in generating the data structure, stacks the images in time order, whereby the pixels for the same physical location are stacked one over another. In this manner, the data structure includes dozens or hundreds of images of the same physical locations, including the target agricultural field, over the time period. Further, optionally, as indicated by the dotted box in FIG. 3, the computing device 102 may generate, at 406, one or more indices based on the data included in the images. Specifically, in this example, the computing device generates multiple vegetative indices, which are indicative of the greenness and/or growth of crops in the target agricultural field (and surrounding the target agricultural field in the images). The specific vegetative indices are based on the band data from the images, including, without limitation, RED, GREEN, BLUE, and NIR, and the vegetative indices include NDVI, BSI, EVI2, and MSAVI, as defined above.

The vegetative indices are added to the data structure, per pixel, per image. That said, it should be appreciated that other indices (e.g., vegetative or otherwise, etc.) may be added to the data structure, or that one or more of NDVI, BSI, EVI2, and MSAVI may be omitted. The specific indices included in the data structure may be dependent on the type of target agricultural field, the type of crop therein, the surroundings, etc.

Next, based on the data structure for the images for the target agricultural field, the computing device 102 performs, at 408, spatiotemporal segmentation on the images represented by the data structure.

In connection therewith, the computing device 102 divides, based on a SNITC or other suitable spatiotemporal clustering algorithm, the image(s) into segments and assigns spatiotemporal super pixels to the defined segments of the image(s). In particular, the clustering algorithm relies on the band/indices data, over time, to cluster the pixels into the segments having limited variation. Once the plurality of segments is defined, the computing device 102 aggregates all the pixel data, for each pixel in the defined segment, per band and/or per indices, into the super pixel for that segment. For example, the super pixel may include separate averages of one or more of NDVI, BSI, EVI2, MSAVI, RED, GREEN, BLUE, NIR, etc. In this manner, the super pixels are a lower resolution representation of the images. The super pixels are then added to the data structure as an additional layer of data.

In addition, the computing device 102 may perform spatiotemporal filtering. In particular, the computing device 102 relies on the NVDI data from the data structure, over time, and applies a Canny edge detection filter (σ=3). As indicated above, the σ parameter defines the windows of the Gaussian smoothing that are initially applied by this filtering approach. In addition, the computing device 102 applies maximum filtering, which includes applying a 3×3 kernel to the image(s) to assign to the center pixel the highest value from the image in the location the kernel overlaps. In this manner, the maximum filtering provides for the edges to be enlarged. The two-stage filtering provides a times series of edges. The computing device 102 combines the time series of edges, through an additive combination, to define one single edge layer. The computing device 102 then binarizes the single edge layer based on the value of each pixel being less than or equal to zero.

In connection with the process described above, the computing device 102 is configured to perform a connected operation on the binary edge layer output, by assigning a given label to each set of pixels that are contiguous, and not separated by an edge. In this manner, edges define a change in the label, whereby contiguous regions are defined and separated by edges. It should be appreciated that a different sized set of pixels and/or shape of pixels may be used to define the regions in other embodiments.

Next, at 410, the computing device 102 performs regionalization on the segmented data structure. This technique is configured to group a large set of spatial objects into a number of spatially contiguous regions. In order to determine the number of regions, in this example embodiment, because the number of agricultural fields in the area is not known beforehand, the device 102 is configured to use a number of connected components in an image, obtained after a spatiotemporal filtering combined with the objective function (Fₛ) (as explained above) that is used to define an optimum number of regions/fields in the time series of images, through an optimization process.

Further, the computing device 102 performs the rectification based on edge detection. In particular, the computing device 102 relies on the NVDI data from the data structure, over time, and applies a Canny edge detection filter (σ=3). As indicated above, the σ parameter defines the windows of the Gaussian smoothing that is initially applied by this filtering approach. In addition, the computing device 102 applies maximum filtering, which includes applying a 3×3 kernel to the image(s) to assign to the center pixel the highest value from the image in the location the kernel overlaps. In this manner, the maximum filtering provides for the edges to be enlarged. The two-stage filtering provides a times series of edges. The computing device 102 combines the time series of edges, through an additive combination, to define one single edge layer. The computing device 102 then binarizes the single edge layer based on the value of each pixel being less than or equal to zero.

As part of region rectification, the computing device 102 performs a connected operation by assigning a given label to each set of pixels that are contiguous (as explained above). In this manner, edges define a change in the label, whereby contiguous regions are defined and separated by edges.

The computing device 102 further imposes a sieve operation, which removes connected components less than a first predefined threshold size. For example, the computing device 102 may merge connected components with a larger (or largest) neighbor when the connected component is less than 500 pixels, 1000 pixels, 2000 pixels, or more or less, etc. Based on the connected operation and the sieve operation, a regionalized image is provided.

In the example method 400, the computing device 102 further perform one or more post-processing operations, at 412, to further defines the field boundaries.

In particular, the computing device 102 is configured to define edges on the images, through edge detection based on spatiotemporal filtering, across the regions in the connected components, or labelled image. The computing device 102 then adds the edges to the labeled image, based on the expression above, which generally changes the labels of the pixels where the edges are detected, as a refined labelled image.

The computing device 102 then uses a four-connected neighborhood, which is the four pixels on top, bottom, left and right sides of a given pixel, to define the regions between the edges of the refined labelled image. In addition, similar to the above, the computing device 102 again imposes a sieve operation, which removes connected components less than a second predefined threshold size (which, in this example, is generally smaller than the first predefined threshold size discussed above). The computing device 102 may further transform the image to vector format.

Thereafter, at 414, the computing device 102 outputs the field boundary for the target agricultural field as a set of polygons. The polygons may then be provided, for example, in response to a request for the field boundary, whereby the polygons are used to define the specific agricultural data for the target agricultural field and enable one or more digital data services for the field. As such, the polygons (and more broadly, the field boundary) may be exported to the one or more digital data services, whereby specific and accurate data may be provided and/or used in implementing the services. In connection therewith, such digital data services may include yield prediction, treatment recommendations, seed recommendations, planting recommendations, and also calculating land use for various purposes such as determining impact of de-forestation, tracking sustainability practices, estimating land disturbance of human activity, etc.

In view of the above, the systems and methods herein provide a remote sensing time series based solution, which provides spatiotemporal segmentation and spatiotemporal filtering combined with regionalization technique. The systems and methods provide a technical solution suited to delineate agricultural field boundaries agnostically regarding to region and the image used.

With that said, it should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects, features, operations, etc. of the present disclosure may transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques, including computer software, firmware, hardware or any combination or subset thereof, wherein the technical effect may be achieved by performing at least one of the following operations: (a) accessing a data set of images, the images defining a time series of images over a time period, each of the images including a target agricultural field; (b) generating a data structure for the target agricultural field including at least a portion of the images; (c) segmenting the images in the data structure into a plurality of segments; (d) aggregating data for the images included in each of the plurality of segments into super pixels; (e) merging the super pixels into spatially contiguous regions; (f) defining a field boundary of the target agricultural field, based on the spatially contiguous regions; (g) filtering the images based on the one or more indices; and/or (h) after merging the super pixels: combining the time series of edges into a single edge layer and binarizing the single edge layer.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above-mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in processing image data, the method comprising:
accessing, by a computing device, a data set of images, the images defining a time series of images over a time period, each of the images including a target agricultural field;
generating, by the computing device, a data structure for the target agricultural field including at least a portion of the images;
segmenting, by the computing device, the images in the data structure into a plurality of segments;
aggregating, by the computing device, data for the images included in each of the plurality of segments into super pixels;
merging, by the computing device, the super pixels into spatially contiguous regions; and
defining, by the computing device, a field boundary of the target agricultural field, based on the spatially contiguous regions.

2. The computer-implemented method of claim 1, wherein the images include at least one image per week during the time period; and/or
wherein accessing the data set of images include accessing the data set of images based on a location included in the target agricultural field.

3. The computer-implemented method of claim 1, wherein generating the data structure includes:
generating one or more indices for the data set of images, per pixel and per image; and
compiling the one or more indices into the data structure.

4. The computer-implemented method of claim 3, wherein the one or more indices include one or more of NDVI, BSI, EVI2, and MSAVI.

5. The computer-implemented method of claim 3, further comprising filtering the images based on the one or more indices.

6. The computer-implemented method of claim 1, wherein segmenting the images in the data structure into a plurality of segments is based on a spatiotemporal clustering algorithm.

7. The computer-implemented method of claim 1, wherein merging the super pixel is based on an edge detection filter and/or a maximum filter to provide a time series of edges.

8. The computer-implemented method of claim 7, further comprising, after merging the super pixels:
combining, by the computing device, the time series of edges into a single edge layer; and
binarizing the single edge layer.

9. The computer-implemented method of claim 1, wherein the merging includes imposing a sieve operation to reduce the spatially contiguous regions, prior to defining the field boundary; and/or
wherein merging the super pixels includes iteratively merging the super pixels.

10. A non-transitory computer-readable storage medium including executable instructions for processing images related to boundaries, which when executed by at least one processor, cause the at least one processor to:
access a data set of images, the images defining a time series of images over a time period, each of the images including a target agricultural field;
generate a data structure for the target agricultural field including at least a portion of the images;
segment the images in the data structure into a plurality of segments;
aggregate data for the images included in each of the plurality of segments into super pixels;
merge the super pixels into spatially contiguous regions; and
define a field boundary of the target agricultural field, based on the spatially contiguous regions.

11. The non-transitory computer-readable storage medium of claim 10, wherein the executable instructions, when executed by the at least one processor to access the data set of images, cause the at least one processor to access the data set of images based on a location included in the target agricultural field.

12. The non-transitory computer-readable storage medium of claim 10, wherein the executable instructions, when executed by the at least one processor to generate the data structure, cause the at least one processor to:
generate one or more indices for the data set of images, per pixel and per image; and
compile the one or more indices into the data structure; and
wherein the executable instructions, when executed by the at least one processor, further cause the at least one processor to filter the images based on the one or more indices.

13. The non-transitory computer-readable storage medium of claim 10, wherein the executable instructions, when executed by the at least one processor, cause the at least one processor to segment the images in the data structure into a plurality of segments based on a spatiotemporal clustering algorithm.

14. The non-transitory computer-readable storage medium of claim 10, wherein the executable instructions, when executed by the at least one processor, cause the at least one processor to merge the super pixel based on an edge detection filter and/or a maximum filter to provide a time series of edges; and
wherein the executable instructions, when executed by the at least one processor, further cause the at least one processor to, after the super pixels are merged:
combine the time series of edges into a single edge layer; and
binarize the single edge layer.

15. The non-transitory computer-readable storage medium of claim 10, wherein the executable instructions, when executed by the at least one processor to merge the super pixels into spatially contiguous regions, cause the at least one processor to:
impose a sieve operation to reduce the spatially contiguous regions, prior to defining the field boundary; and/or
iteratively merge the super pixels.

16. A system for use in processing images related to boundaries, the system comprising a computing device configured to:
access a data set of images, the images defining a time series of images over a time period, each of the images including a target agricultural field;
generate a data structure for the target agricultural field including at least a portion of the images;
segment the images in the data structure into a plurality of segments;
aggregate data for the images included in each of the plurality of segments into super pixels;
merge the super pixels into spatially contiguous regions; and
define a field boundary of the target agricultural field, based on the spatially contiguous regions.

17. The system of claim 16, wherein the computing device is configured, in order to generate the data structure, to:
generate one or more indices for the data set of images, per pixel and per image; and
compile the one or more indices into the data structure; and
wherein the computing device is further configured to filter the images based on the one or more indices.

18. The system of claim 16, wherein the computing device is configured to segment the images in the data structure into a plurality of segments based on a spatiotemporal clustering algorithm.

19. The system of claim 16, wherein the computing device is configured to merge the super pixel based on an edge detection filter and/or a maximum filter to provide a time series of edges; and
wherein the computing device is further configured to:
combine the time series of edges into a single edge layer; and
binarize the single edge layer.

20. The system of claim 16, wherein the computing device is configured, in order to merge the super pixels into spatially contiguous regions, to:
impose a sieve operation to reduce the spatially contiguous regions, prior to defining the field boundary; and/or
iteratively merge the super pixels.
